(19) United States
(12) Patent Application Publication
(10) Pub. No.: US 2005/0143068 A1
(43) Pub. Date: Jun. 30, 2005

(54) Device, system and method of communication system monitoring for wireless user equipment

(75) Inventors: Guy Ben-Yehuda, Raanana (IL); Yoav Volloch, Kfar Saba (IL); David Ben-Eli, Modiin (IL)

Correspondence Address: EITAN, PEARL, LATZER & COHEN ZEDEK LLP, 10 ROCKEFELLER PLAZA, SUITE 1001, NEW YORK, NY, 10020, US

(73) Assignee: Intel Corporation

(21) Appl. No.: 10/748,665

(22) Filed: Dec. 31, 2003

(51) Int. Cl. H04Q 7/20

(52) U.S. Cl. 455/434

(57) ABSTRACT

In a wireless communications system, during a base station or cell monitoring procedure, a device, system, and method may enable a communication device to determine if a serving base station is transmitting an adequate signal, and, if the base station is not transmitting an adequate signal, identifying another base station that may provide adequate service. For example, it may be determined if at least one other base station in a list of previously identified base stations transmits adequate signals. If this is not the case, a scan may be performed of a set of channels to identify further base stations or cells.

### BACKGROUND OF THE INVENTION

Mobile and other wireless systems may use various protocols for communications. Various mobile and wireless communication devices, referred to herein as user equipment (UE), may monitor sets of transceivers or cells, for example, signal availability, signal quality, etc. For example, the Universal Mobile Telecommunications System (UMTS) is a third generation (3G) cellular mobile communications system that may support, for example, UMTS Terrestrial Radio Access Network (UTRAN) communication. The specifications defining UMTS are formulated by the 3rd Generation Partnership Project (3GPP), and may be found in “IMT-2000 DS-CDMA System”, Association of Radio Industries and Businesses (ARIB) Standard, ARIB STD-T63 Ver. 3.10, published Sep. 26, 2002. The UMTS communication system, as defined by the 3rd Generation Partnership Project (3GPP), may require compliance of Wideband Code Division Multiple Access WCDMA), which is related to third generation (3G) wireless systems, and second to third generation (2.5G) wireless systems. UEs that support UMTS Terrestrial Radio Access Network (UTRAN) communication systems, as defined by 3GPP, may require monitoring of neighboring cells that may be used for cell reselection, for example, in the case where a serving cell signal becomes weak, distorted, noisy, or hindered Monitoring may require, for example, regular base station searches or identification procedures that may include initiating a UE radio frequency (RF) antenna to monitor signals from neighboring transceivers.

Monitoring of neighboring transceivers, base stations or cells, for example, to enable effective cell, transceivers or base station reselection, may consume relatively high amounts of power, possibly impacting significantly on the power consumption of the UE. Certain systems may restrict the times of such monitoring. For example, an idle or other reduced function state may be defined, where reduced or no idling (and a reduction or cessation of other activity) may occur. During an idle state, for example, a UE may be required to monitor a paging or other channel (e.g., a radio channel assigned to a base station and used to set up calls to mobile devices) in a cellular network in order to detect incoming calls. A UE may further be required to execute cell or transceiver reselection that may include, for example, selecting GSM served cells, WCDMA served cells, or other suitable wireless communication cell types. Other wireless communications systems may face similar issues in cell or transceiver monitoring and selection.

### BRIEF DESCRIPTION OF THE DRAWINGS

Embodiments of the present invention may be better understood and appreciated from the following detailed description taken in conjunction with the appended drawings, it being understood that these drawings are given for illustrative purposes only and are not meant to be limiting, wherein:

FIG. 1 is a simplified block-diagram illustrating an exemplary communication system in accordance with some aspects of exemplary embodiments of the present invention; and

FIG. 2 is a flow chart illustrating an exemplary method to monitor communications systems in a wireless network, according to an exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Additionally, lice reference numerals may indicate corresponding, analogous, or similar elements.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the description of embodiments of the invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Embodiments of the invention may include sequences of acts, functions, or operations leading to a desired result. These may include physical manipulations of physical quantities. These quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing”, “defining”, “calculating”, “computing”, “determining” or the like, refer to the actions and/or processes of a computer or computing system, or similar electronic computing devices, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses or devices to perform the operations herein. Such devices, as described hereinbelow, may include various types of communication devices that may be used in conjunction with embodiments of the present invention, including mobile stations, cellular telephones, devices including cellular communications capabilities, laptop or notebook computers, Personal Digital Assistants (PDA's), mini computers, pocket computers, wearable computers, paging devices, servers, wire, wireless, or cable modems, or any other communication devices. Such communication devices may be for example universal mode devices, operating using one or more Radio Access Technologies (RAT). For example, dual mode devices or multi-mode devices may be used, hereinafter referred to as “universal mode” devices, which are adapted to use multiple RATs.

Devices or apparatuses that may be used in conjunction with embodiments of the present invention may be specially constructed for the desired purposes, or they may comprise a general-purpose computing devices selectively activated or reconfigured by a program stored in such a device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable to store electronic instructions, and capable of being coupled to a system bus for a computing device.

The processes and displays presented herein are not inherently related to any particular computing device or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

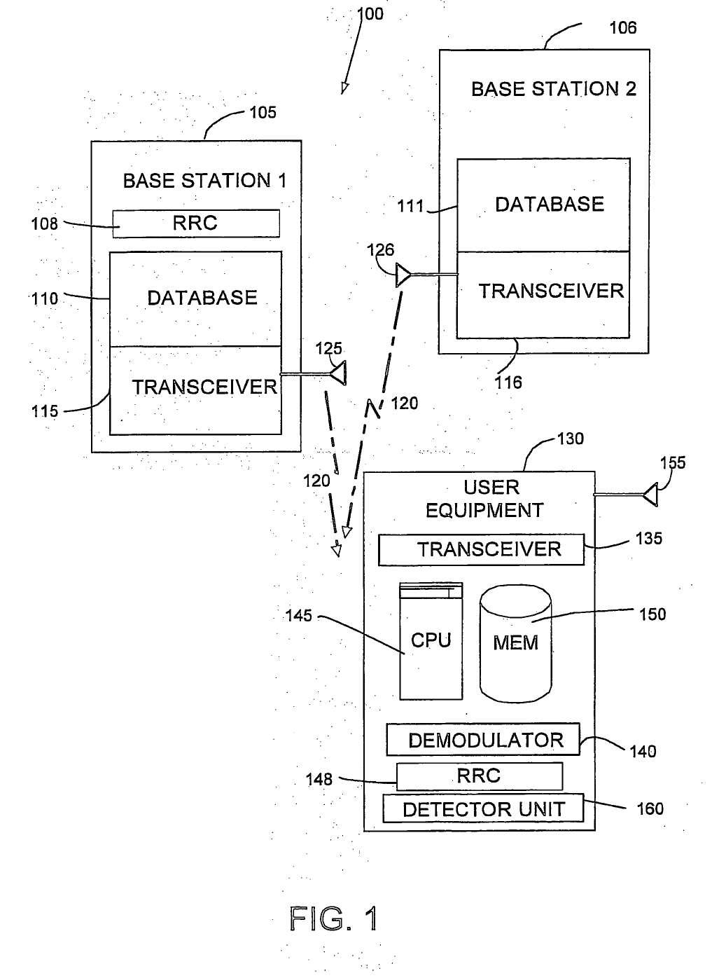

Reference is now made to FIG. 1, which illustrates an exemplary communication system 100 in accordance with an aspect of an embodiment of the present invention. Communications system 100 may be for example a cellular system such as a UTRAN based communications system, which may include, for example, a set of Base Stations (BSs), e.g., BS 105 and BS 106. BSs 105 and 106 may transmit data to and receive data from other base stations, cellular phones, paging services and other wireless transmission systems within at least one cell or other area that may be served by signals from respective BSs 105 and 106. Transceiving units other than cellular base stations may be used with embodiments of the present invention, and in certain embodiments, communications systems not using cellular systems and methods may be used. Other numbers of BSs may be used.

BSs 105 and 106 may communicate with a UE 130 or any other suitable communication device over a communication channel 120 using, for example, UTRAN technology. Other suitable standards or communications methods may be used. Communications system 100 may include any suitable number of BSs. Communication channel 120 may be, for example, a wireless link of a wireless communications system, part of a wide-area-network (WAN), local-area-network (LAN) or any other network. For example, the system may be a Wireless Local Area Network (WLAN) system or a digital subscriber line (DSL) system, or other type of network. According to aspects of the invention, communication device 130 may be operated at a relatively low energy-consumption rate, by operating according to a power saving mode. A power saving mode, according to some embodiments of the present invention, may be defined as an operation mode, for example, which consumes less energy when a device operates, for example, in an idle state or another reduced power or reduced functionality state. The various embodiments of the method described herein may be performed by, for example, communication device 130 and/or an associated processing platform, for example, a processor and associated instructions as described in detail below, although other suitable devices and/or platforms may perform embodiments of the method. While power saving and reduced power modes are associated with some embodiments of the invention, in other embodiments power saving or reduced power modes need not be used.

BS 105 and 106 may be for example, transmission and/or receiving stations in a wireless telecommunications system, for example a UTRAN communications system 100. BS 105, for example, may be a serving base station, which may include a transceiver 115 or other suitable equipment to, for example, generate signals for one or more UEs 130 and/or other BSs in at least the geographical or other area to which signals may be served by BS 105. BS 105 may include a database 110, to store system data, BS data, user data and other suitable data. BS 105 may include a Radio Resource Control (RRC) layer 108 or other suitable layers to communicate with other devices, stations etc. A serving BS relative to a communications device may be defined as a BS that is currently transmitting communication data to and/or receiving communication data from that communication device. BS 106, for example, may be a neighboring base station, which may have a transceiver 116 to generate signals for two or more communication devices 130 and/or other base stations. BSs 105 and 106 may respectively include databases 110 and 111 or other suitable systems to respectively store relevant system data for, for example, a cellular communications system or another type of communications system, and/or other data BSs 105 and 106 may respectively include antennas 125 and 126, such as, for example, internal antennas, dipole antennas, omni-directional antennas, monopole antennas, end fed antennas, circularly polarized antennas, micro-strip antennas, diversity antennas, or other suitable antennas, to transmit and/or receive signals to and from a plurality of communication devices 130 and/or base stations. A serving base station such as 105 or 106 may be a transmission station, for example, that is currently transmitting signals to and receiving signals from at least one cell or geographical area and may thereby be broadcasting signals to and receiving signals from one or more UEs 130, for example, UTRAN UEs.

UE 130 may be, for example, a communication device that may operate with UTRAN standards, for example, 3GPP TS 25.133 V6.3.0 (published September 2003). UE 130 may include an antenna 155 and a transceiver 135, which may include a transmitter, receiver, and any other suitable communication components. Transceiver 135 may enable receiving of incoming signals and transmitting of outgoing signals, via for example antenna 155, if desired. Antenna 155 may be, for example, an internal antenna, dipole antenna, omni-directional antenna, monopole antenna, end fed antenna, circularly polarized antenna, micro-strip antenna, diversity antenna, or other suitable antenna. Transceiver 135 may include, for example, a demodulator 140, and/or other suitable equipment. In some embodiments, transceiver 135 and antenna 155 may be implemented, for example, using separate and/or integrated units. UE 130 may include a demodulator 140, which may be implemented in hardware and/or software, and which may be used, for example, to demodulate received signals.

Communication device 130 may include a processing platform, for example, embodied within a controller or processor (e.g., CPU) 145, which may execute for example instructions such as executable code that may enable operation of communication device 130 according to some embodiments of the present invention. Communication device 130 may include a memory unit 150, to store relevant data and instructions etc. Communication device 130 may include a Radio Resource Control RRC) layer 148 to communicate with other UEs, BSs etc. UEs may operate using suitable systems and standards other than UTRAN.

Although the scope of embodiments of the present invention is not limited in this respect, processor 145 may include an application specific integrated circuit (ASIC), an application specific standard product (ASSP), a reduced instruction set circuit (RISC), a complex instruction set computer (CISC), a digital signal processor (DSP), a central processing unit (CPU), or another suitable processor or set of processors. System data, executable code, and/or instructions, etc., to enable processor 145 to perform methods of embodiments of the present invention, may be stored in a memory, disk, or other suitable storage device. Such instructions may be stored, for example, in memory 150, such as a flash card, or other suitable storage medium. Instructions may include computer-readable code, algorithms, definitions, and calculations, etc. Any other suitable computing or communication components may be used. Execution of the instructions may be performed by processor 145, or any other suitable components. The instructions may also be embodied in hardware or any suitable combination of software and/or hardware in accordance with specific implementations of embodiments of the invention.

Design considerations, such as, but not limited to, processor performance, cost and power consumption, may result in a particular processor design, and it should be understood that the design of processor 145 is merely an example, and that embodiments of the invention are applicable to other processor designs as well.

Although the scope of embodiments of the present invention is not limited in this respect, communication system 100 shown in FIG. 1 may be part of a UTRAN communication system or another suitable communications system, with base stations 105 and 106 being transmission stations, and UE 130 being a mobile station, a pager communication device, a personal digital assistant (PDA) and/or any other suitable communications device. According to some embodiments of the present invention, communication system 100 may enable wireless communications using, for example, 3rd Generation Partnership Project (3GPP) technology, such as, for example, Frequency Domain Duplexing (FDD), Wideband Code Division Multiple Access (WCDMA) or other suitable systems.

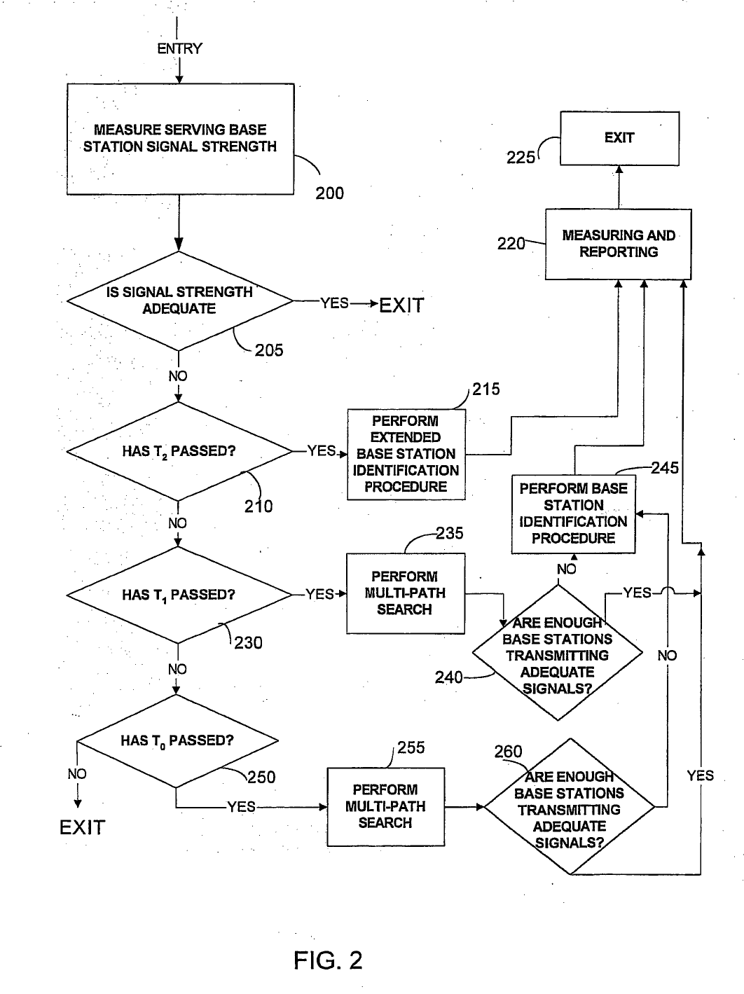

Reference is now made to FIG. 2, which illustrates a method of communication system monitoring, for example, to enable effective cell or base station reselection, in a wireless communications system, according to an exemplary embodiment of the present invention. At selected or random intervals the UE 130 may record an input signal from a BS. For example, a UE 130 may receive a signal from, for example, a RRC layer 108 of a serving base station (BS), for example, BS 105. Such a signal may include administrative information such as neighboring transceivers or base stations, protocols, capabilities, etc. Other signals, such as data or voice signals, may be received. A UE 130, for example, using the UE RRC layer 148, may read system information from the serving BS 105, which may send, for example, a list which may include neighboring transceivers or base stations (e.g., BS 106 and possibly other transceivers), to UE 130. The RRC of UE 130 may send the paging indication channel (PICH) of serving BS 105 a reception request, wherein UE 130 may ask to measure the signal quality being transmitted by the serving BS 105. Other systems for sending administrative or descriptive information may be used. Furthermore, other protocols and standards, other than the UTRAN standard, may be used.

At block 200, UE 130 or other mobile device may measure the quality of the signal being received from a cell, transmitter or base station, such as the serving or current BS 105. For example, UE 130 may record the received signal, and may measure the incoming signal quality. Various methods for measuring signal quality, which are known in the art, may be used.

At block 205 UE 130 or other mobile equipment may determine whether the quality of the received signal is adequate, for example whether or not it is above a predetermined threshold or meets a defined criteria or level, such as for example a base station selection criterion (S). The UB 130 may report the results of this procedure, for example, to the UE RRC 148. In the case where the signal quality is adequate or meets a certain criteria (e.g., S), there may be no need for a further search for suitable transceivers. For example, there may be no need for a base station identification procedure or base station search, for example, to scan a set of SYNC or other suitable channels to locate neighboring base stations that may be able to serve adequate signals to UE 130. In such a case, the process may be exited.

In some embodiments, a count of time elapsed may be kept, and this may be used, for example, to evaluate the need for certain actions to be taken. Such time may be absolute or may be relative to certain events (e.g., the start of operations of a device, the time since a last action was taken, etc.). For example, various system, signal quality, or service evaluations may tale place after certain pre-determined time intervals have passed.

At block 210, in the case where the signal quality is not adequate or does not meet a certain selection criterion, UE 130 may determine whether an interval T₂ has elapsed. For example, from a starting time or UE wake up time T₀, UE 130 may determine whether an extended base station evaluation interval has passed. For example, such an interval T₂ may be defined as NxT_Evaluate, where T_Evaluate is defined in the 3GPP 25.133 specification, and N is a design parameters being any number or fraction of a number greater than 1 by which the T_Evaluate interval may be multiplied. In one embodiment, interval T₂ is longer than interval T₁ (described below) which in turn is longer than interval T₀ (described below). However, the relationships between he intervals may vary, and other numbers of intervals may be used. Furthermore, in other embodiments, interval lengths may not be factored into a decision process.

At block 215, in the case where T₂ (e.g., NxT_Evaluate, but other suitable intervals may be used) has passed, UE 130 may perform a search for transceivers or base stations beyond the search for “known” or previously identified equipment. Such a search to identify further base stations (e.g., a base station identification procedure or a search) may, for example, require scanning a set of SYNC or other channels (where a set may include one unit). Such scanning, for example, may be executed without advance knowledge of the timing of SYNC channels used by targeted equipment, may require longer transceiver or receiver time (and possibly more power consumption) than a multi-path search for previously identified equipment. For example, in one embodiment, a base station identification procedure BS identification procedure may be performed. A BS search or BS identification procedure may, for example, include a search executed online by a UE, for example, by scanning a set of SYNC channels for neighboring base stations. A BS identification procedure may be performed by a UE by opening its RF channel for a selected time interval to detect a variety of received signals. A BS identification procedure may be, for example, a search procedure wherein a communication device operates its RF receiver for an interval of approximately 50-150 mS. Other time intervals may be used, such that the time during which the UE RF channel is made to operate determines the accuracy of the search. Channels other than SYNC channels may be analyzed.

For example, the RF channel operation times may be varied to perform, for example, “extended”, “normal”, “limited”, and/or other BS identification procedures or combinations of BS identification procedures, the searches providing respective result accuracy according to the search time period. According to an embodiment of the present invention an “extended” BS identification procedure may be performed at T₂, which may be substantially longer than a “normal” BS identification procedure (e.g., 100-150 mS), to provide a relatively thorough check for neighboring BSs. Such checks may be performed on a relatively infrequent basis, as compared to “normal” BS identification procedures as generally implemented. At block 215, for example, an “extended” BS identification procedure may be performed, wherein the UE RF antenna 155 may operate for a longer period than required by a standard or “normal” BS identification procedure. Usage of “extended” BS identification procedures may enable, for example, UE to perform relatively few and infrequent BS identification procedures interspersed with lighter identification procedures or searches, for example, multi-path searches, thereby enabling significant power savings. Alternatively, a “normal” BS identification procedure may be performed, or any alternative BS identification procedures or combinations of BS identification procedures may be performed at T₂.

At block 220, the results gained from the BS identification procedure, for example, “extended” BS identification procedure, may be measured, for example, using a multi-path search procedure or another suitable procedure, and reported, for example, to the UE RRC 148.

At block 225 the communications system monitoring may be exited.

At block 230, in the case where T₂, for example, an “extended” BS evaluation interval (e.g., NxT_Evaluate) has not passed, it may be determined whether an interval T₁, for example, a standard BS evaluation interval has passed. For example, T_Evaluate may define T₁, as defined in the 3GPP 25.133 specification. Other suitable lengths for T₁ may be used.

At block 235, in the case where T₁ (e.g., T_Evaluate) has passed, the mobile device such as UE 130 may perform a search to determine, from a list or database of “known” or previously identified BSs or cells, if at least one other BS or cell, or any other number of BSs or cells, in the list transmits adequate signals. A previously identified BS or cell may be from a list of cells, transmitters, or base stations previously identified from, for example, previous communications involving a BS, and/or from information sent from a service provider, etc. For example, UE 130 may perform a multi-path search that may include searching previously identified BSs that were previously detected by UE 130 during a previous selected time interval, and for which UE 130 may know the timing intervals at which signals from these BSs are transmitted. Such list or database of previously identified equipment may be stored in, for example, a database in memory unit 150. The multi-path search may be conducted by UE 130 by, for example, finding the paths of all or selected previously identified BSs, and receiving buffer or other data relating to the input signals from these BSs, as is known by those skilled in the art. For example, UE 130 may record an input signal from a previously identified BS for a selected time interval. A multi-path search may be executed, for example, over a buffer of recorded samples. UE 130 may process the recorded signal(s) of the previously identified BSs while the RF receiver is off. This relatively short time interval may be adequate to record the signal quality data since the UE may already “know” the timing of the various BS data transmissions. Other time intervals and/or search criterion may be used.

At block 240, UE 130 may measure the incoming signals and determine whether adequate signals are being received from a pre-determined number (e.g., at least one) of BSs from the list or database of previously identified base stations or cells. UE 130 may, for example, estimate the signal qualities of the “identified” BSs. For example, UE 130 may process the buffer data received to determine the respective qualities of the received signals. UE 130 may determine, according to a pre-selected threshold, whether the qualities of the signals being transmitted by the various previously identified BSs are adequate, according to a predetermined threshold or a defined cell selection criterion (e.g., S) etc.

At block 245, in the case where adequate signals are not being received by a pre-selected number of BSs, if a first interval (e.g., T₁) has passed, the UE may scan a set of SYNC or other suitable channels for a first scanning time period. For example, a “limited” base station search may be initiated. A “limited” BS identification procedure may be, for example, a search procedure wherein a communication device operates its RF receiver for an interval of, for example, approximately 10-50 milliseconds (mS). Other time intervals may be used. UE 130 may perform a “limited”, “normal”, “extended” or any combination of BS identification procedures. Such a “limited” BS identification procedure may be adequate to provide relevant data for neighboring BSs, since these “limited” BS identification procedures may be interspersed between “extended” BS identification procedures which may be executed, for example, at T₂, as described above.

At block 220, in the case where adequate signals are being received from a pre-determined number of BSs, the results may be measured, for example by performing a multi-path search or other suitable procedures, and reported, for example, to the UE RRC 148.

At block 225 the communications system monitoring may be exited.

At block 250, in the case where T₁ (e.g., T_Evaluate) has not passed, it may be determined whether, for example, an interval T₀ has passed, for example, a BS measurement interval. For example, T₀ may be defined by T_Measure, as defined by the 3GPP 25.133 specification. For example, To may be the (initial) interval at which a UE wakes up or starts up its BS monitoring procedure. Other suitable lengths for T₀ may be used.

At block 255, in the case where To has passed, UE 130 may initiate a multi-path search or other search for “known” or previously identified equipment, by, for example, recording input signals from one or more previously identified BSs, as described above in relation to block 235.

At block 260, UE 130 may determine whether adequate transmission signals have been detected from a pre-selected number of BSs located during the multi-path search at block 255.

At block 245, in the case where adequate signals are not being received by a pre-selected number of BSs, a base station search may be performed, for example, a “limited” BS identification procedure, as described above. Other suitable types of BS identification procedures may be performed.

At block 220, in the case where adequate signals are being received from a pre-selected number of BSs, the results may be measured, for example by performing a multi-path search or other suitable procedures, and reported, for example, to the UE RRC 148.

At block 225 the communications system monitoring may be exited. In the case where relevant BSs have not been detected, the process may be restarted.

Other functions, operations, or combinations of operations may be implemented.

While certain features of embodiments of the present invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the present invention.

1. A method comprising:
determining, during a base station monitoring procedure, if a signal transmitted by a base station currently transmitting data to a communications device is received at a communications device according to an adequate quality, and, if the signal received is not of an adequate quality, determining if a signal transmitted by at least one other base station in a list of identified base stations is received according to an adequate quality at said communications device, and, if a signal of adequate quality of at least one other base station is not received at said communications device, performing a base station identification procedure.

2. The method of claim 1, wherein said performing a base station identification procedure includes a base station search.

3. The method of claim 1, wherein performing said base station identification procedure comprises:
if a first time interval has passed, performing a base station identification procedure for a first time period, and if a second time interval has passed, the second time interval being longer than the first time interval, performing a base station identification procedure for a second time period, the second time period being longer than the first time period.

4. The method of claim 3, wherein performing said base station identification procedure for a second time period comprises performing an extended base station identification procedure.

5. The method of claim 3, comprising determining at said initial time interval, the initial time interval being shorter than said first time interval, if a signal received from at least one other base station in a list of identified base stations is received according to an adequate quality at said communications device, and, if said at least one other signal of adequate quality is not received by said communications device, performing a base station identification procedure.

6. The method of claim 5, wherein performing a base station identification procedure comprises performing a limited base station identification procedure.

7. The method of claim 1, comprising determining signal quality adequacy of a signal received from an identified base station by comparing the signal quality of a signal received from an identified base station to a predetermined threshold.

8. An apparatus, comprising:.
a controller capable of determining, during a base station monitoring procedure, if a signal transmitted by a base station currently transmitting data to a mobile device is received according to an adequate quality, and, if the signal received is not of adequate quality, determining if at least one other base station in a list of identified base stations transmits a signal which is received according to an adequate quality, and, if said at least one other base station does not transmit a signal which is received according to an adequate quality, performing a base station identification procedure.

9. The apparatus of claim 8, wherein said controller is capable of scanning a set of SYNC channels for further base stations.

10. The apparatus of claim 9, wherein the controller is capable of, if a first interval has passed, scanning a set of SYNC channels for a first time period, and is capable of, if a second interval has passed, the second interval being longer than the first interval, scanning a set of SYNC channels for a second time period, the second time period being longer than the first time period.

11. The apparatus of claim 9, wherein the controller is capable of performing an extended base station identification procedure during said second time period.

12. The apparatus of claim 8, wherein said controller is capable of determining signal quality adequacy according to a predetermined threshold.

13. The apparatus of claim 8, wherein said controller is capable of determining, at an initial interval, the initial interval being shorter than said first interval, if at least one other base station in a list of identified base stations transmits a signal which is received according to an adequate quality, and is capable of, if said at least one other signal of adequate quality is not received, scanning a set of SYNC channels for further base stations.

14. The apparatus of claim 13, wherein said scanning a set of SYNC channels for further base stations comprises performing a limited base station identification procedure.

15. A system, comprising:
a dipole antenna; and
a controller capable of determining, during a cell monitoring procedure, if a signal transmitted by a base station currently transmitting data to a mobile device is received according to an adequate quality, and, if the signal received is not of an adequate quality, capable of determining if at least one other base station in a list of identified base stations transmits a signal which is received according to an adequate quality, and, if said signal of adequate quality is not received, capable of performing a base station identification procedure.

16. The system of claim 15, wherein the controller, if a first interval has passed, is capable of scanning a set of SYNC channels for a first time period, and if a second interval has passed, the second interval being longer than the first interval, is capable of scanning a set of SYNC channels for a second time period, the second time period being longer than the first time period.

17. The system of claim 15, wherein said controller is capable of determining signal adequacy according to a predetermined threshold.
an article comprising a storage medium having stored thereon instructions that, when executed by a processing platform, result in:
determining during a base station monitoring procedure if a signal from a base station currently transmitting data to a communications device is received by said communication device according to an adequate quality;
if said signal received is not of adequate quality, determining if at least one other base station in a list of identified base stations transmits a signal which is received by said communication device according to an adequate quality; and
if said at least one other base station does not transmit a signal which is received by said communication device according to an adequate quality, scanning a set of SYNC channels for further base stations.

18. The article of claim 17, wherein the instructions, when executed by the processing platform, result in, if a first interval has passed, scanning a set of SYNC channels for a first time period, and if a second interval has passed, the second interval being longer than the first interval, scanning a set of SYNC channels for a second time period, the second time period being longer than the first time period.

19. The article of claim 17, wherein the instructions, when executed by the processing platform, result in determining signal adequacy according to a predetermined threshold.

20. A method comprising:
during a base station monitoring procedure, at a base station evaluation interval, performing a multi-path search to determine whether at least one identified neighboring base station transmits a signal which is received by a communication device according to an adequate quality.

21. The method of claim 20, comprising, in the case where the received signal from said multi-path search does not meet a selected criterion, performing a base station identification procedure.

22. The method of claim 20, comprising executing said multi-path search over a buffer of recorded samples.

23. The method of claim 20, comprising, at a second interval being greater than said base station evaluation interval, performing an extended base station identification procedure.

24. The method of claim 20, comprising at a base station measurement interval:
performing a multi-path search;
evaluating the results of said search; and
if signals being received to said communication device do not meet pre-selected criteria, performing a base station identification procedure.
